(19) United States
(12) Patent Application Publication
(10) Pub. No.: US 2007/0236828 A1
(43) Pub. Date: Oct. 11, 2007

(54) MAGNETO-FLUIDIC SEAL WITH VIBRATION COMPENSATION

(75) Inventors: Yuri O. Mikhalev, Ivanovo (RU); Sergei G. Lysenkov, Ivanovo (RU)

Correspondence Address: BARDMESSER LAW GROUP, P.C., 910 17TH STREET, N.W., SUITE 800, WASHINGTON, DC, 20006, US

(73) Assignee: Ferrolabs, Inc., Dulles, VA (US)

(21) Appl. No.: 11/278,831

(22) Filed: Apr. 6, 2006

(51) Int. Cl. G11B 33/14

(52) U.S. Cl. 360/97.02

(57) ABSTRACT

A magneto-fluidic seal includes a shaft mounted using an upper bearing and a lower bearing, a disk joined with the shaft, and a sleeve joined with the disk and rotating using a sleeve bearing. A pole piece substantially surrounds the sleeve and has a gap between the pole piece and the sleeve. A plurality of field concentrators are in the gap for maintaining magnetic fluid for sealing the gap. The shaft, disk and sleeve act as a substantially integrally formed element. An O-ring can be between the disk and the shaft, and/or between the disk and the sleeve.

### FIELD OF THE INVENTION

The present invention relates generally to magneto-fluidic seals and to compensating for vibration of a shaft of a system with a magneto-fluidic seal.

### BACKGROUND OF THE INVENTION

When a magnetic field is not present, a magnetic fluid, or ferrofluid, functions like a typical fluid, for example, taking the shape of a container in which it is stored. However when subjected to a magnetic field, the magnetic particles within the fluid align with the magnetic flux lines provided by an associated magnet. Magneto-fluidic seals, utilizing a magnetic fluid, are particularly useful for forming seals around shafts, for example rotating shafts such as a stirring shaft for a reactor or bioreactor, or a power delivery shaft. These magneto-fluidic seals are particularly useful for forming a hermetic environment for the exclusion of contaminants and preventing escape of biological matter from an enclosed space into the environment.

Conventional magneto-fluidic seals for shafts are formed between a pole piece and a sleeve affixed to the shaft. The pole piece includes a annular-shaped magnet defining north and south polarities of the pole piece. The pole piece and the sleeve are separated by a gap. Magnetic fluid fills the gap, forming a hermetic seal between the pole piece and the sleeve.

The magnetic fluid generally includes a suspension of dispersed magnetic particles coated with an anti-aggregation agent that forms a colloid.

One of the problems frequently encountered in the field of magneto-fluidic seals is an insufficient pressure differential that the seal is capable of handling, and insufficient reliability of the magneto-fluidic seal. Due to parts tolerances in the manufacture of the shaft and various components of the magneto-fluidic seal, as well as due to dimensioning and vibration of bearings used in magneto-fluidic seals, the axis of rotation of the shaft, and the center axis of the other cylindrical components of the magneto-fluidic seal become non-coaxial. At the same time, the maximum pressure differential that the seal is capable of handling drops, due to the fact that the working gap, in which the magnetic fluid is located, around the shaft acquires different dimensions on different sides of the shaft. In other words, the magnetic field gradient acquires an azimuthal component. At this moment, where the working gap is the largest, the magnetic field becomes the weakest, and the magneto-fluidic seal fails at that location. The reduction in the working pressure differential and the appearance of the azimuthal component of the magnetic field leads to a substantial reduction in the reliability and other characteristics of the magneto-fluidic seal.

Another problem in the conventional magneto-fluidic seals is an inefficient use of the magnetic fluid. Since the body of the sleeve, at the location of the channel where magnets are located, carries a saturated magnetic current, the magnetic field lines start escaping from the sleeve into the gap between the sleeve and the shaft, particularly into areas where there is no magnetic fluid. Also, this phenomenon results in pushing the magnetic fluid away from the field concentrators. In effect, this magnetic liquid no longer “works” for the task of providing a magneto-fluidic seal.

A common problem in magneto-fluidic seals and mechanisms that use magneto-fluidic seals is low critical pressure at which the seals will fail. Typically, this critical pressure is dependent upon the geometry of the seal, the working gap between the sleeve and the shaft, the strength of the magnetic field, and other parameters. One of the factors that degrades the performance of the magneto-fluidic seals and lowers the critical pressure is vibration of the shaft.

Due to the vibration, the working gap in which the magnetic fluid is located, instead of being symmetrical and uniform about the center axis of the shaft, becomes asymmetrical. This means that the magnetic flux distribution around the circumference of the shaft is no longer uniform. The overall magnetic field can be obtained by integration of the magnetic flux over a surface, and essentially stays constant. This means that when the shaft vibrates, and at some point in time the center axis of the shaft is no longer coincident with the center axis of the sleeve, there are locations in the working gap where there are fewer magnetic flux lines, and other locations in the gap where there are more flux lines. Consequently, the effectiveness of the magneto-fluidic seal at a point where there are fewer magnetic flux lines becomes lower. The seal will therefore fail at that point, meaning that the critical pressure at which the magneto-fluidic seal fails is less than the design pressure for a perfect nonvibrating seal.

Thus, what is needed is a magneto-fluidic seal structure that can handle vibration without losing effectiveness of the seal, and a magneto-fluidic seal whose critical pressure does not depend on vibration of the shaft.

### BRIEF SUMMARY OF THE INVENTION

Accordingly, the present invention is directed to a magneto-fluidic seal with vibration compensation that substantially obviates one or more of the disadvantages of the related art.

In one embodiment, a magneto-fluidic seal includes a pole piece surrounding a shaft, a magnet conducting a magnetic field to the pole piece, and a plurality of magnetic field concentrators between the pole piece and the shaft. A magnetic fluid is in a gap between the field concentrators. The gap increases generally in the direction of lower pressure. The gap has a substantially conical profile or a substantially parabolic profile. The field concentrators are formed integrally with the shaft, or integrally with the pole piece.

In another embodiment, a magneto-fluidic seal includes a shaft mounted using an upper bearing and a lower bearing, a disk joined with the shaft, and a sleeve joined with the disk and rotating using a sleeve bearing. A pole piece substantially surrounds the sleeve and has a gap between the pole piece and the sleeve. A plurality of field concentrators are in the gap for maintaining magnetic fluid for sealing the gap. The shaft, disk and sleeve act as a substantially integrally formed element. An O-ring can be between the disk and the shaft, and/or between the disk and the sleeve.

In another embodiment, a magneto-fluidic seal includes a shaft mounted using an upper bearing and a lower bearing, a substantially disk-like structure mounted perpendicular to the shaft, and a sleeve rotationally mounted around the shaft. The shaft, disk-like structure and sleeve function as a unitary element. A pole piece substantially surrounds the sleeve and has a gap between the pole piece and the sleeve. Magnetic fluid is in the gap to act as a seal.

It is to be understood that both the foregoing general description and the following detailed description are exemplary and explanatory and are intended to provide further explanation of the invention as claimed.

### BRIEF DESCRIPTION OF THE DRAWINGS/FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 is partial sectional view of one embodiment of a magneto-fluidic seal that uses a conical profile of magnetic field concentrators.

FIG. 2 is a partial sectional view of another embodiment of the magneto-fluidic seal that compensates for bending of the shaft.

### DETAILED DESCRIPTION OF THE INVENTION

Reference will now be made in detail to embodiments of the present invention, examples of which are illustrated in the accompanying drawings.

The present invention provides for an increase in the pressure differential that a magneto-fluidic seal can handle, as well as for an increase in magneto-fluidic seal reliability through a greater uniformity in the gap dimension between the various rotating and static elements of the magneto-fluidic seal, as well as through a more efficient use of magnetic fluid in the magneto-fluidic seal.

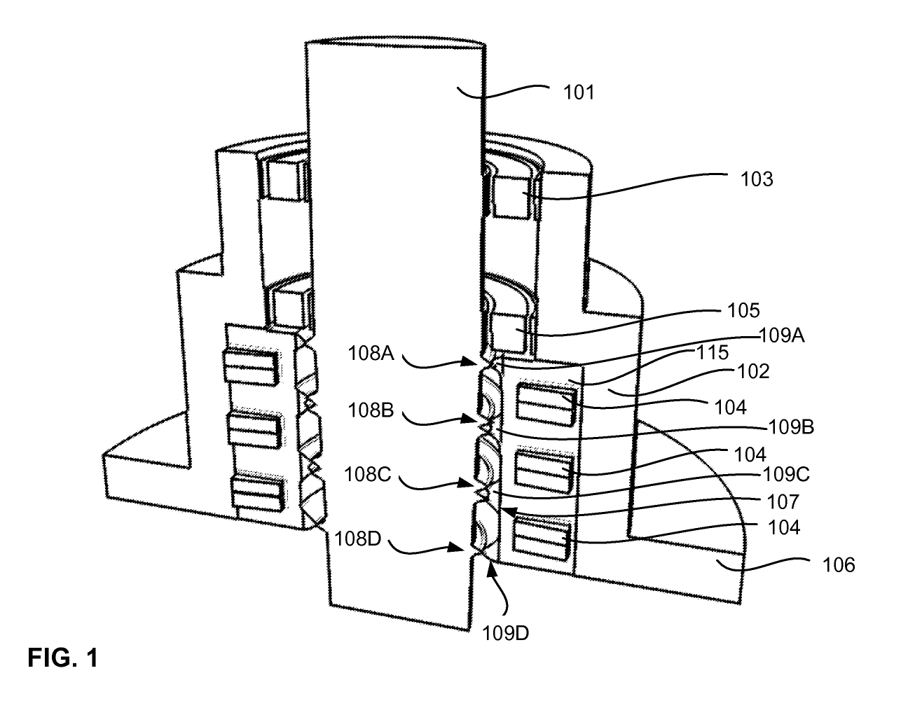

FIG. 1 illustrates one approach to addressing the reduction of critical pressure in magneto-fluidic seals due to vibration. Shown in FIG. 1 is a shaft 101, surrounded by a sleeve 102 with a pole piece 115. At least one magnet 104, and typically a plurality of magnets 104, are positioned within the pole piece 115. The sleeve 102 can have a flange 106, to attach to the rest of the construction, which may be a bioreactor, a chemical reactor, or the like. The shaft rotates, and is held in place using bearings 103 and 105. A number of field concentrators are located along the length of the shaft 101, the concentrators being designated 108A, 108B, 108C, 108D. Some of the field concentrators 108 can themselves consist of multiple sharp points to increase the magnetic field intensity locally. Magnetic fluid is located in the working gap between the pole piece 115 and the shaft 101, with the magnetic fluid forming, in effect, “rings” around the shaft. The magnetic fluid is designated by 109A, 109B, 109C and 109D to correspond to the field concentrators 108A-108D.

As further shown in FIG. 1, the working gap gradually increases in the direction of 108A to 108D. This corresponds to the higher pressure being at the top of this figure, and the lower pressure at the bottom of the figure, in other words, the pressure gradient is generally in the direction from top to bottom.

As will be appreciated from FIG. 1, the working gap increases in a generally conical manner, with the smallest gap being at the field concentrator 108A, and the largest gap being at the field concentrator 108B.

With the arrangement illustrated in FIG. 1, two opposite effects take place—the field intensity weakens somewhat, but the uniformity of the field as a function of the angle around the circumference of the shaft is greater. In other words, the larger the working gap, the less the effect of vibration is on the field distribution. At the same time, the larger the gap, the lower the magnetic field intensity used to maintain the magneto-fluidic seal in place. It turns out that given the relatively small dimensions and issues (e.g., typical working gaps are on the order of a fraction of a millimeter), the “desirable effect” is greater than the undesirable effect. The overall magnetic fluid, as noted above, is obtained by integrating the magnetic flux density over a surface that encloses the magnetic field concentrators 108. The increase in the working gap (which is not shown to scale in FIG. 1), has only a relatively modest effect on the total magnetic field, which, as noted above, is obtained by integration over a surface. However, the impact on the uniformity of the magnetic flux distribution is much more substantial. Thus, the net result is that by having a working gap that increases in the direction of the pressure gradient, the critical pressure is higher than it otherwise would be. Therefore, the seal is more reliable and less susceptible to the effect of vibration.

It will be appreciated that the profile of the working gap need not be conical, as shown in FIG. 1. For example, the profile can be parabolic, as well as other shapes, as long as the working gap has a general increase in the same direction as the pressure gradient. Also, more or fewer field concentrators 108 can be used, compared to what is shown in the figure. Furthermore, the field concentrators may be located on the pole piece 104, rather than on the shaft 101.

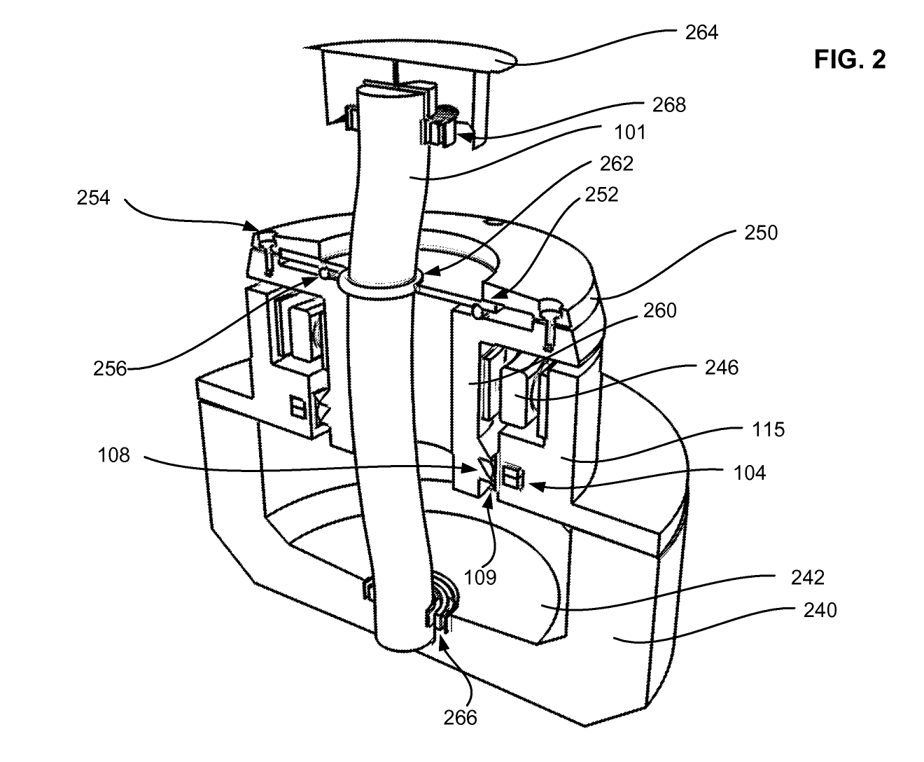

FIG. 2 illustrates one solution to this problem. Shown in FIG. 2 is a bioreactor housing 240, with a cavity 242 in which the biological matter, or other chemical matter, may be located. The shaft 101 is mounted using a bearing 266 on the bottom of the housing 240. Also shown in this figure is a sleeve 260, with field concentrators 108 and magnetic fluid 109.

Magnets 104 are located in a pole piece 115, as shown in the figure. Bearing 246, such as a roller bearing, or a ball bearing is used to mount the sleeve 260 relative to the pole piece 115. A lid 250 is attached using screws or other similar fasteners 254 to the sleeve 260. Element 252 is a ring like structure, that is held in place by two O-rings 256 and 262. The shaft 101 is also fixed in a mounting structure 264, which can use bearing 268 for the rotational mounting of the shaft 101.

As may be further seen from FIG. 2, the disk 252 may be conceptually viewed as a unitary element, together with the shaft 101 and the O-ring 262. In other words, it is useful to image the disk 252 being welded to the shaft 101. The objective here is to ensure that the axes of the three bearings—268, 246 and 266, are always coaxial. To that end, the disk 252 is essentially fixed in place between the lid 250 and the sleeve 260, optionally using the O-ring 256. The entire structure is aligned upon assembly, so that the axes of rotation of the three bearings 268, 246 and 266 are coaxial, as noted above. Thus, when the shaft 101 starts rotating, regardless of the bending of the shaft 101, the axes of the three bearings will continue to be aligned and coaxial. Therefore, the bending of the shaft 101 (which is shown in a highly exaggerated form in FIG. 2—in reality, such bending is typically on the order of a millimeter, or even a fraction of a millimeter) will not affect the alignment of the bearings. Therefore, the bending of the shaft 101 will not result in undesirable vibration that will degrade the effectiveness of the magnetic fluid 109, which can continue to act effectively as a seal.

While specific configurations and arrangements are discussed, it should be understood that this is done for illustrative purposes only, by way of example only, and not limitation. A person skilled in the pertinent art will recognize that other configurations and arrangements can be used without departing from the spirit and scope of the present invention. It will be apparent to a person skilled in the pertinent art that this invention can also be employed in a variety of other applications. Thus, the breadth and scope of the present invention should not be limited by any of the above-described exemplary embodiments, but should be defined only in accordance with the following claims and their equivalents.

What is claimed is:

1. A magneto-fluidic seal, comprising:
a pole piece surrounding a shaft, the shaft being mounted on a bearing;
a magnet conducting a magnetic field to the pole piece;
a plurality of magnetic field concentrators between the pole piece and the shaft; and
a magnetic fluid in a gap between the field concentrators,
wherein the gap increases generally in a direction away from the bearing.

2. The seal of claim 1, wherein the gap has a substantially conical profile.

3. The seal of claim 1, wherein the gap has a substantially parabolic profile.

4. The seal of claim 1, wherein the field concentrators are formed integrally with the shaft.

5. The seal of claim 1, wherein the field concentrators are formed integrally with the pole piece.

6. A magneto-fluidic seal comprising:
a shaft mounted using an upper bearing and a lower bearing;
a disk joined with the shaft;
a sleeve joined with the disk and rotating using a sleeve bearing;
a pole piece substantially surrounding the sleeve and having a gap between the pole piece and the sleeve;
a plurality of field concentrators in the gap, the field concentrators maintaining magnetic fluid for sealing the gap,
wherein the shaft, disk and sleeve act as a substantially integrally formed element.

7. The seal of claim 6, further comprising an O-ring between the disk and the shaft.

8. The seal of claim 6, further comprising an O-ring between the disk and the sleeve.

9. A magneto-fluidic seal comprising:
a shaft mounted using an upper bearing and a lower bearing;
a substantially disk-like structure mounted perpendicular to the shaft;
a sleeve rotationally mounted around the shaft, wherein the shaft, disk-like structure and sleeve function as a unitary element;
a pole piece substantially surrounding the sleeve and having a gap between the pole piece and the sleeve; and
a magnetic fluid in the gap.

10. The seal of claim 9, further comprising an O-ring between the disk-like structure and the shaft.

11. The seal of claim 9, further comprising an O-ring between the disk-like structure and the sleeve.
